(19) United States
(12) Patent Application Publication
(10) Pub. No.: US 2026/0128641 A1
(43) Pub. Date: May 7, 2026

(54) VIBRATION ABSORPTION SYSTEM OF HUB MOTOR AND APPLICATION THEREOF

(71) Applicant: Liujia Qiqu Technology (Suzhou) Co., Ltd., Suzhou (CN)

(72) Inventor: Peixiang ZHANG, Suzhou (CN)

(73) Assignee: Liujia Qiqu Technology (Suzhou) Co., Ltd., Suzhou (CN)

(21) Appl. No.: 19/435,826

(22) Filed: Dec. 30, 2025

Related U.S. Application Data
(63) Continuation of application No. PCT/CN2024/092597, filed on May 11, 2024.

(30) Foreign Application Priority Data
Nov. 21, 2023 (CN) 2023115588142
Apr. 24, 2024 (CN) 2024208671906
Apr. 24, 2024 (CN) 2024208673028

(51) Int. Cl. H02K 5/24; B60G 11/16

(52) U.S. Cl. CPC H02K 5/24; B60G 11/16; B60G 2204/13; B60G 2204/182; B60G 2204/4191

(57) ABSTRACT

The present application discloses a vibration absorption system of a hub motor and an application thereof. The vibration absorption system of the hub motor comprises a brake, a vibration absorption mechanism, a torque transmission mechanism, and a hub motor; the brake is primarily used for braking and torque transmission; the vibration absorption mechanism is used for reducing an acting force of a weight of the motor on a vehicle hub, reducing hub loads, and increasing a reaction speed of the hub; and the torque transmission mechanism is used for indirectly transmitting rotational torque of the motor to the vehicle hub, and at the same time, for preventing the vehicle hub from transmitting a high-frequency large-magnitude impact force to the hub motor together with the vibration absorption mechanism and reducing an unsprung mass of a vehicle using the hub motor.

### CROSS-REFERENCE TO RELATED APPLICATIONS

The application claims priority to Chinese patent application No. 2023115588142, filed on Nov. 21, 2023, Chinese patent application No. 2024208673028 and 2024208671906, filed on Apr. 24, 2024, the entire contents of which are incorporated herein by reference.

### TECHNICAL FIELD

The present application relates to the technical field of vehicle hub motors, and particularly relates to a vibration absorption system of a hub motor and an application thereof.

### BACKGROUND

With the development of new energy technologies, the popularity of new energy electric vehicles is higher and higher; in recent years, main engine plants and component suppliers in various countries around the world are making the layout in the field of vehicle hub motors, which clearly shows that the hub motors will be the development direction of the new energy vehicle industry in future, but the hub motor design still has many technical difficulties at present, for example, the inner space of wheels is limited, the requirements for the power density performance of the motors are high, the design difficulty is large, and the mounting of brake discs is limited; for example, the hub motors will be subjected to large road impact loads, and the requirements for vibration resistance of motors are severe; existing inner-rotor and outer-rotor hub motors are directly fixed on the vehicle hubs, the weights of the motors are generally designed at around 30 Kg, greatly increasing the unsprung mass of the vehicles, so that the overall mass inertia of the vehicle hubs is increased, and the vibration absorption reaction is dull during running on uneven roads, and the comfort and manoeuvrability of driving the vehicles are affected; and if the hub motors are directly connected to the hubs, the hubs transmit high-frequency large-amplitude impacts received directly to the hub motors, affecting the internal structural stability and service life of the motors. The hub motors have restricted the development of the new energy vehicles.

### SUMMARY

An objective of the present disclosure is to provide a vibration absorption system of a hub motor, a vibration absorption mechanism and a torque transmission mechanism are provided between the hub motor and a hub as well as a frame, so as to solve the problem of vibration caused by an increase in unsprung mass of the hub motor and running on an uneven road surface in order to overcoming the shortcomings of the prior art.

To achieve the above objective, the present disclosure provides technical solutions as follows:

An embodiment of the present application discloses a vibration absorption system of a hub motor, including a hub, a hub motor, a torque transmission mechanism, a vibration absorption mechanism, and a pull-up vibration absorber, where
the torque transmission mechanism includes a driving disc drivingly connected to the hub motor through an intermediate disc, the driving disc is connected to the hub, the intermediate disc is drivingly connected to the hub motor, and two sides of the intermediate disc are connected to the hub motor and the driving disc through several connecting rods, respectively;
a vibration absorption mechanism includes a steering knuckle, the steering knuckle is rotationally connected to the driving disc, and the hub motor is slidingly connected to the steering knuckle or slidingly connected to a frame through connection rods; and
the pull-up vibration absorber has one end connected to the hub motor and the other end connected to a frame of a vehicle.

Further, in the vibration absorption system of the hub motor described above, the hub motor is an inner-rotor motor or an axial flux motor, and comprises a stator disposed in a housing, a rotor, and a rotor shaft drivingly connected to the rotor, the rotor shaft is of a hollow structure, and the intermediate disc is drivingly connected to the hub motor through a planetary mechanism.

Further, in the vibration absorption system of the hub motor described above, the planetary mechanism includes an internal gear ring disposed on an outer wall of the rotor shaft, an external gear ring disposed on an inner wall of the housing, and several planet gears disposed on a first planet carrier, one end of the first planet carrier that is far away from the planet gears is drivingly connected to the intermediate disc, and the ends of the planet gears that are far away from the torque transmission mechanism are provided with a second planet carrier.

Further, in the vibration absorption system of the hub motor described above, the hub motor is an outer-rotor motor and includes a motor front cover, a rotor iron core, permanent magnets, a stator iron core, a stator support, a motor bearing, and a motor rear cover.

Further, in the vibration absorption system of the hub motor described above, the steering knuckle includes a connecting plate as well as a connecting shaft and a connector which are disposed on two sides of the connecting plate, respectively, and a side surface of the connecting plate that is close to the hub motor is slidingly connected to a side surface of the stator support.

Further, in the vibration absorption system of the hub motor described above, each connection rod has one end connected to the side surface of the stator support, respectively and the other end connected to the frame.

Further, in the vibration absorption system of the hub motor described above, the intermediate disc is drivingly connected to the motor front cover through several connecting rods, a brake bottom plate and a brake shoe assembly for braking are disposed in the driving disc, the brake bottom plate is fixed to the steering knuckle, a center block is slidingly disposed in the stator support, an end surface of one side of the brake bottom plate is fixed to the center block, vibration absorption springs and a vertical vibration absorber are connected between the center block and the stator support, and the stator support has the side surface provided with a first fixing post and is connected to the frame of the vehicle through a diagonal vibration absorber.

Further, in the vibration absorption system of the hub motor described above, one end of each connecting rod disposed close to the driving disc is connected to the driving disc through a first shaft pin, one end of each connecting rod disposed close to the hub motor is connected to the hub motor through a second shaft pin, one end of each connecting rod that is far away from the corresponding first shaft pin or the corresponding second shaft pin is connected to the intermediate disc through a third shaft pin, the first shaft pins, the second shaft pins and the third shaft pins are respectively arrayed on a circumference of the same diameter size at an equal interval, and a number of the connecting rods disposed between the driving disc and the intermediate disc and a number of the connecting rods disposed between the motor front cover and the intermediate disc are at least 3.

Further, in the vibration absorption system of the hub motor described above, rotating arms respectively corresponding to the first shaft pins are disposed on the outer wall of the driving disc in a protruding manner, and the intermediate disc is disposed between the rotating arms and the hub motor and is sleeved on the driving disc in a suspended manner.

Further, in the vibration absorption system of the hub motor described above, a rectangular slot is disposed in a middle of the stator support, two sides of the center block are slidingly connected to inner walls of two opposite sides of the rectangular slot through guide rails and sliding blocks, respectively, side surfaces of the stator support and the center block that are close to the diagonal vibration absorber are respectively provided with second fixing posts for mounting of the vertical vibration absorber, and the vibration absorption springs are respectively disposed between the center block and side walls of the rectangular slot that are perpendicular to the guide rails.

Further, in the vibration absorption system of the hub motor described above, the guide rails are disposed on a side surface of the stator support that is far away from the intermediate disc in parallel, and the center block is slidingly connected to the guide rails through the sliding blocks.

An embodiment of the present application also discloses a wheel, including the vibration absorption system of the hub motor as described above, where a hub is sleeved with a tire.

An embodiment of the present application also discloses a vehicle, including the tire as described above.

Compared to the prior art, advantages of the present disclosure are as follows: the vibration absorption system of the hub motor is compact in structure; on one hand, the torque transmission mechanism is composed of the hub motor front cover together with the intermediate disc and the driving disc, equal torque and equal rotational speed of the hub motor are indirectly transmitted to the vehicle hub, the vehicle hub can vibrate up and down within a range of motion of the torque transmission mechanism, and a vibration frequency and a vibration amplitude cannot be transmitted to the hub motor; on the other hand, the motor stator support bears the weight of the hub motor, and the weight of the hub motor is transferred to the vehicle frame through the diagonal vibration absorber, thereby relieving a downward acting force of the hub motor on the vehicle hub; at the same time, a high-frequency large-amplitude impact force generated by the vehicle hub during driving on the ground is absorbed through the vibration absorption mechanism to ensure that the hub motor keeps the relative position stable; and the vibration absorption springs and the vertical vibration absorber can quickly adjust the center block and the center position the stator support through vibration absorption and damping effects to adjust the hub motor and the vehicle hub to keep the relative stable positions and provide comfort and maneuverability for driving the vehicle.

### BRIEF DESCRIPTION OF THE DRAWINGS

To describe the technical solutions in the embodiments of the present application or in the prior art more clearly, the following briefly introduces the accompanying drawings required for describing the embodiments or the prior art. Apparently, the accompanying drawings in the following description show only some embodiments recorded in the present disclosure, and those of ordinary skill in the art may still derive other drawings from these accompanying drawings without creative efforts.

FIG. 1 shows an exploded diagram of a vibration absorption system of a hub motor according to a specific embodiment 1 of the present disclosure.

FIG. 2 shows a sectional view of the vibration absorption system of the hub motor according to the specific embodiment 1 of the present disclosure.

FIG. 3 shows a mounting diagram of a torque transmission mechanism according to the specific embodiment 1 of the present disclosure.

FIG. 4 shows a mounting diagram of a vibration absorption mechanism according to the specific embodiment 1 of the present disclosure.

FIG. 5 shows a structure diagram of the torque transmission mechanism according to the specific embodiment 1 of the present disclosure.

FIG. 6 shows a structure diagram of the vibration absorption mechanism according to the specific embodiment 1 of the present disclosure.

FIG. 7 shows a structure diagram of a driving disc according to the specific embodiment 1 of the present disclosure.

FIG. 8 shows a structure diagram of a vibration absorption system of a hub motor according to a specific embodiment 2 of the present disclosure.

FIG. 9 shows a structure diagram of a vibration absorption system of a hub motor according to a specific embodiment 3 of the present disclosure.

FIG. 10 shows a structure diagram of a vibration absorption system of a hub motor according to a specific embodiment 4 of the present disclosure, in which a hub is omitted.

FIG. 11 shows a structure diagram of a driving disc according to the specific embodiment 4 of the present disclosure.

FIG. 12 shows a structure diagram of a vibration absorption system of a hub motor according to a specific embodiment 5 of the present disclosure.

FIG. 13 shows a structure diagram of a vibration absorption system of a hub motor according to a specific embodiment 6 of the present disclosure.

FIG. 14 shows a structure diagram of a vibration absorption system of a hub motor according to a specific embodiment 7 of the present disclosure.

FIG. 15 shows an exploded diagram of the vibration absorption system of the hub motor according to the specific embodiment 7 of the present disclosure.

FIG. 16 shows a sectional view of the vibration absorption system of a hub motor according to the specific embodiment 7 of the present disclosure.

FIG. 17 shows an internal diagram of a planetary mechanism according to the specific embodiment 7 of the present disclosure.

FIG. 18 shows a mounting diagram of a planet gear according to the specific embodiment 7 of the present disclosure.

FIG. 19 shows a structure diagram of a rotor shaft according to the specific embodiment 7 of the present disclosure.

FIG. 20 shows a structure diagram of a housing according to the specific embodiment 7 of the present disclosure.

FIG. 21 shows a structure diagram of a first planet carrier according to the specific embodiment 7 of the present disclosure.

FIG. 22 shows a structure diagram of a hub motor according to the specific embodiment 7 of the present disclosure.

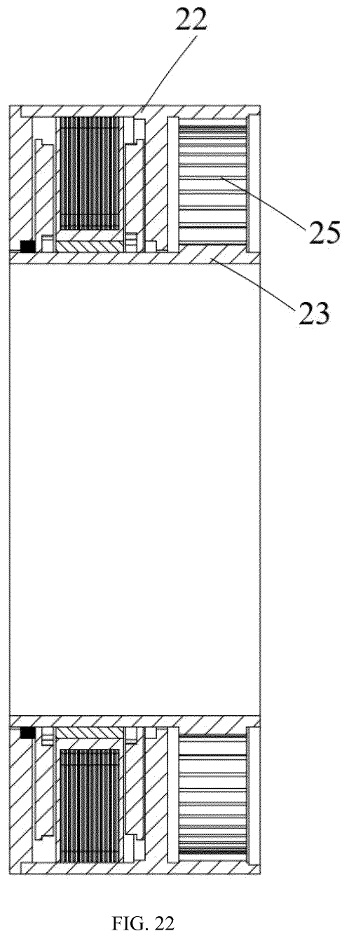

FIG. 23 shows a structure diagram of a vibration absorption system of a hub motor according to a specific embodiment 8 of the present disclosure.

FIG. 24 shows an exploded diagram of the vibration absorption system of the hub motor according to the specific embodiment 8 of the present disclosure.

FIG. 25 shows a sectional view of a vibration absorption system of a hub motor according to the specific embodiment 9 of the present disclosure.

### DETAILED DESCRIPTION OF THE EMBODIMENTS

The following describes the technical solutions in the embodiments of the present disclosure in details with reference to the accompanying drawings in the examples of the present disclosure. Apparently, the described examples are merely some rather than all of the examples of the present disclosure. All other embodiments obtained by a person of ordinary skill in the art based on the embodiments of the present disclosure without making creative efforts shall fall within the scope of protection of the present disclosure.

In the description of the present disclosure, it should be noted that the orientations or positional relationships indicated by the terms “center”, “up”, “down”, “left”, “right”, “vertical”, “horizontal”, “inside”, “outside”, and the like are based on those shown in the accompanying drawings, intended only for the convenience of describing the present disclosure and for simplifying the description, and not intended to indicate or imply that the referred device or element must be provided with a particular orientation or constructed and operated with a particular orientation, therefore not allowed to be construed as a limitation of the present disclosure. Furthermore, the terms “first”, “second”, and “third” are used for descriptive purposes only and not allowed to be construed as an indication or implication of relative importance.

In the description of the present disclosure, it should be noted that unless otherwise explicitly provided and limited, the terms “mounted”, “attached”, “connected” should be understood in a broad sense, for example, it may be a fixed connection, a detachable connection or an integral connection; it may be a mechanical connection or an electrical connection; it may be a direct attachment, or an indirect attachment through an intermediate medium; and it may be a communication within two elements. For those of ordinary skill in the art, the specific meaning of the above terms in the present disclosure can be construed according to specific cases.

### EMBODIMENT 1

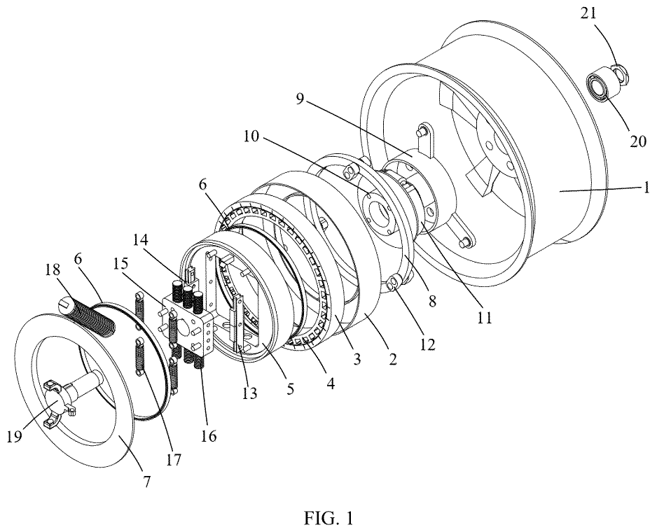

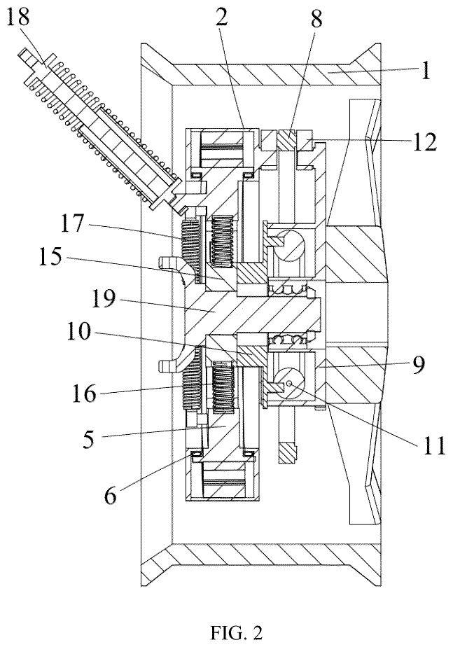

Referring to FIG. 1 to FIG. 7, a vibration absorption system of a hub motor, including a hub 1, a hub motor, a torque transmission mechanism, a vibration absorption mechanism, and a diagonal vibration absorber, where
the hub motor includes a motor front cover 2, a rotor iron core 3, permanent magnets, a stator iron core 4, a stator support 5, a motor bearing 6, and a motor rear cover 7, one side of the stator support 5 that is close to the diagonal vibration absorber is provided with a first fixing post for connecting the diagonal vibration absorber, the diagonal vibration absorber can utilize an existing suspension unit and other structures, the first fixing post is integrally formed on the stator support or fixed to the stator support through a conventional thread structure or the like as long as the diagonal vibration absorber can be connected, or it can be replaced by a pull-up vibration absorber;
the torque transmission mechanism includes a driving disc 9 drivingly connected to the motor front cover 2 through an intermediate disc 8, and a brake base plate 10 and a brake shoe assembly 11 for braking, and two sides of the intermediate disc 8 are connected to the motor front cover 2 and the driving disc 9 through three connecting rods 12, respectively;
the vibration absorption mechanism includes a center block 15 slidingly connected to the stator support 5 through guide rails 13 and sliding blocks 14, and vibration absorption springs 16 and a vertical vibration absorber 17 are connected between the center block 15 and the stator support 5;
the diagonal vibration absorber 18 has one end connected to the first fixing post of the stator support 5 and the other end connected to a frame of a vehicle (not shown).

In this technical solution, the hub, the guide rails, the sliding blocks, the brake bottom plate, and the brake shoe assembly are all of conventional structures, structures recorded in the prior art can be directly utilized, the brake bottom plate is fixed to the center block through bolts or the like, the brake shoe assembly is disposed in the driving disc (which may also be referred to as a “brake drum”), the hub motor may also utilize structures of the prior art, with the difference that the center block is slidingly disposed inside the stator support, a drum brake structure of the hub motor is composed of the driving disc together with the brake bottom plate and the brake shoe assembly, one side of the driving disc is fixed to the hub of the vehicle through a conventional bolt structure, an end surface of one side of the brake bottom plate is fixed to the center block and fixed together with the center block to the conventional steering knuckle 19, one end of the steering knuckle close to the frame is connected to a steering mechanism of the vehicle through a conventional connecting structure, the other end of the steering knuckle is rotationally connected to the driving disc through a bearing 20 and a nut 21 or the like, the steering knuckle is circumferentially fixed to the center block through a conventional key and other structures, and steering of the hub is achieved by the steering knuckle; the motor front cover, the rotor iron core and the permanent magnets, the stator iron core, the motor bearing, and the motor rear cover are mounted on the stator support to jointly form an outer-rotor hub motor, the motor front cover and the motor rear cover are rotationally connected to the stator support through motor bearings, respectively, after the hub motor is energized, the rotor iron core drives the motor front cover and the motor rear cover to rotate and transmits equal torque and equal rotational speed of a driving force to the hub of the vehicle through the torque transmission mechanism composed of the connecting rods as well as the intermediate disc and the driving disc, thereby driving the vehicle to travel; the diagonal vibration absorber pulls the stator support upward and transfers the entire weight of the hub motor upward to the frame of the vehicle; the vibration absorption mechanism is composed of the guide rails, the sliding blocks, the center block, the vibration absorption springs, and the vertical vibration absorber, the center block is slidingly disposed inside the stator support through the guide rails and the sliding blocks, when the vehicle is driving on a road surface, the weight of the hub motor is not directly applied to the center block and the steering knuckle, ensuring that the vehicle travels with the hub without loads, and when the road surface is rough or has obstacles, the motor front cover, the intermediate disc, and the driving disc may be offset in a vertical direction, the hub of the vehicle can move up or down through obstacles with light and fast speed, the hub drives the center block to slide along the guide rails, the high-frequency large-amplitude transient impact force is absorbed in the forms of thermal energy and elastic deformation under the joint vibration absorption and damping effects of the diagonal vibration absorber, the vertical vibration absorber, and the vibration absorption springs, ensuring that the hub motor and the hub of the vehicle keep relatively smooth positions to provide comfort and manoeuvrability for driving the vehicle.

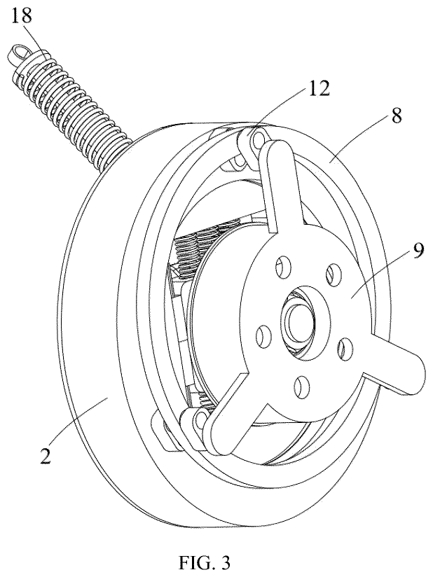

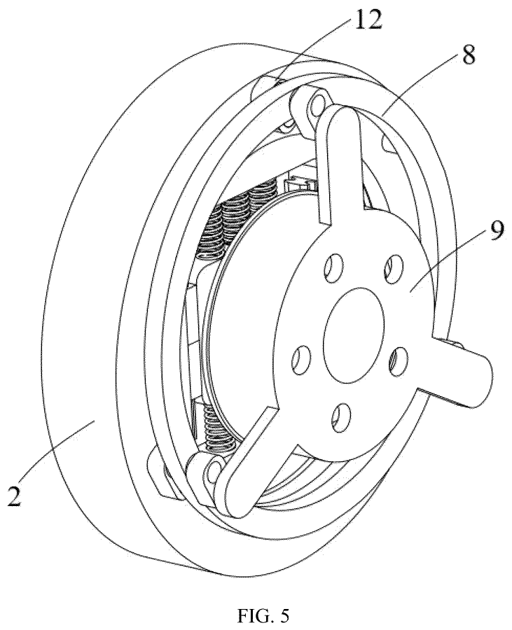

Exemplarily, referring to FIG. 3 and FIG. 5, one end of each connecting rod 12 disposed close to the driving disc 9 is connected to the driving disc 9 through a first shaft pin, one end of each connecting rod 12 disposed close to the motor front cover 2 is connected to the motor front cover 2 through a second shaft pin, one end of each connecting rod 12 that is far away from the corresponding first shaft pin or second shaft pin is connected to the intermediate disc 8 through a third shaft pin, the first shaft pins, the second shaft pins, and the third shaft pins are respectively arrayed on a circumference of the same diameter size at an equal interval, and a number of the connecting rods 12 disposed between the driving disc 9 and the intermediate disc 8 and a number of the connecting rods 12 disposed between the motor front cover 2 and the intermediate disc 8 are 3.

In this technical solution, the first shaft pins, the second shaft pins, and the third shaft pins are directly identical, are correspondingly fixed to the driving disc, the intermediate disc, and the motor front cover through interference fit or screwed connection or other conventional manners, respectively, two ends of each third shaft pin protrude out of the intermediate disc to be rotationally connected to the connecting rods on corresponding sides, respectively, the connecting rods are of block-like structures, are each provided with two pin holes, and are rotationally connected to the corresponding first shaft pins, second shaft pins, and third shaft pins, through the rotation of the connecting rods, conventional devices such as bearings/bushings can also be embedded in the pin holes to improve the smoothness of rotation, the motor front cover, the intermediate disc, and the driving disc are offset from each other, i.e., when the wheel of the vehicle passes through rough road surfaces or has obstacles, the vibration frequency and the vibration amplitude are not transmitted to the hub motor due to the rotation of the connecting rods and the corresponding shaft pins, the use environment of the hub motor is improved, and the service life of the hub motor is prolonged.

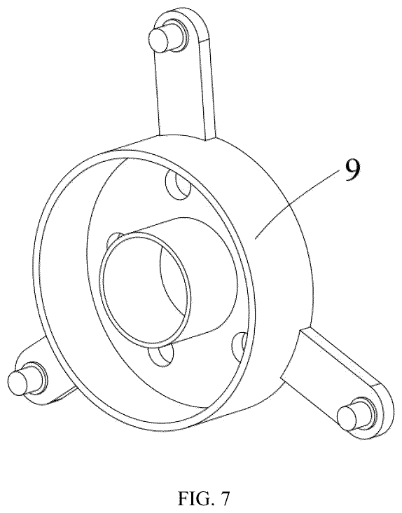

Exemplarily, referring to FIG. 3, FIG. 5, and FIG. 7, the outer wall of the driving disc 9 is provided with rotating arms corresponding to the first shaft pins, respectively in a protruding manner, and the intermediate disc 8 is disposed between the rotating arms and the motor front cover 2 and is sleeved on the driving disc 9 in a suspended manner.

In the technical solution, the rotating arms and the driving disc are integrally formed to ensure the entire strength, the first shaft pins are fixed to the corresponding rotating arms through manners such as interference fit or screw connection, and then connected to the intermediate disc through the connecting rods, and the intermediate disc is sleeved on the driving disc in a suspended manner to prevent interference of the offset of the driving disc; in the operation process, the motor front cover transmits rotational torque of the hub motor to the intermediate disc through the second shaft pins, the third shaft pins, and the corresponding connecting rods, the intermediate disc then transmits the rotational torque to the rotating arms on the driving disc through the third shaft pins, the first shaft pins, and the corresponding connecting rods, and the hub is driven by the driving disc to rotate; when the hub of the vehicle jounces (moves up or down), the motor front cover and the intermediate disc can offset with respect to the rotating arms in the vertical direction to maintain stability of the hub motor; when the hub and the hub motor are coaxial, the distance between the outer wall of the motor front cover and the inner wall of the hub is greater than twice a center distance of two pin holes in the same connecting rod to avoid interference between the hub motor and the hub; and similarly, the distance between the inner wall of the intermediate disc and the outer wall of the driving disc is greater than the center distance of two pin holes in the same connecting rod to avoid interference between the intermediate disc and the driving disc.

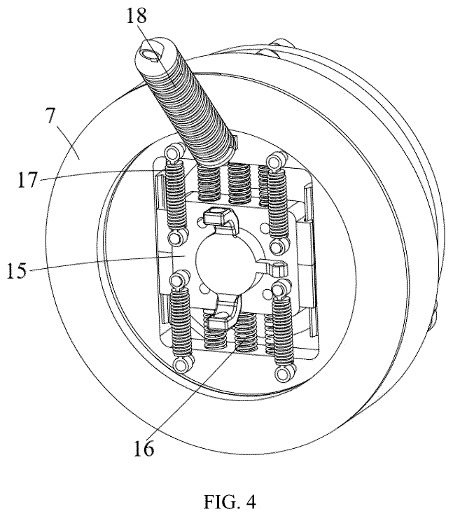

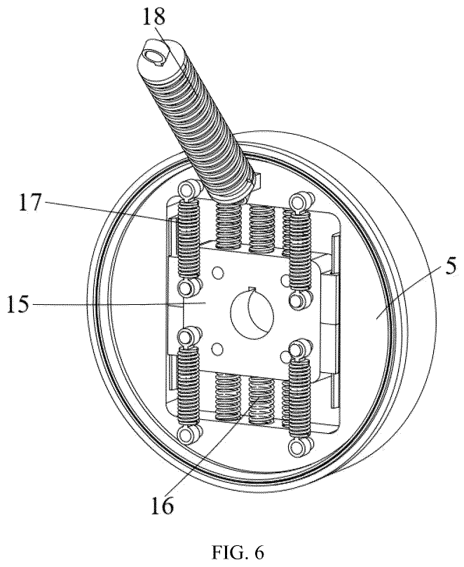

Exemplarily, referring to FIG. 4 and FIG. 6, a rectangular slot is disposed in the middle of the stator support 5, the guide rails 13 are vertically fixed to inner walls of two opposite sides of the rectangular slot, respectively, and two sides of the center block 15 are slidingly connected to the corresponding guide rails 13 through the sliding blocks 14, respectively.

In this technical solution, when the hub of the vehicle jounces (moves up or down), the center block and the steering knuckle are driven to move along linear guide rails to reduce vibration of the hub motor; the generated high-frequency large-amplitude impact force can be absorbed by the vibration absorption springs and the vertical vibration absorber to ensure that the hub motor keeps the relative position smooth; and meanwhile, the vibration absorption springs and the vertical vibration absorber can quickly adjust the center block and the center position of the stator support through vibration absorption and damping effects to adjust the hub motor and the vehicle hub to maintain the relative smooth positions to provide comfort and maneuverability for driving the vehicle.

Exemplarily, referring to FIG. 4 and FIG. 6, the side surfaces of the stator support 5 and the center block 15 close to the diagonal vibration absorber 18 are respectively provided with second fixing posts for mounting of the vertical vibration absorber 17.

In this technical solution, the second fixing posts are fixed to the stator support and the center block through a conventional form such as threads, and are used for connecting two ends of the vertical vibration absorber. An existing structure such as a spring damper is selected as the vertical vibration absorber to achieve elastic connections between the center block and the stator.

Exemplarily, referring to FIG. 4 and FIG. 6, the vibration absorption springs 16 are provided between the center block 15 and the side walls of the rectangular slot that are perpendicular to the guide rails 13, respectively.

In this technical solution, vibration absorption springs are provided between the top and bottom ends of the center block and the corresponding inner walls of the rectangular slot respectively, so that vibration of the hub to the hub motor due to jounces is reduced, the top and bottom ends of the center block and the corresponding inner walls of the rectangular slot are respectively provided with positioning grooves corresponding to the vibration absorption springs, and misalignment of the vibration absorption springs and the like are avoided.

### EMBODIMENT 2

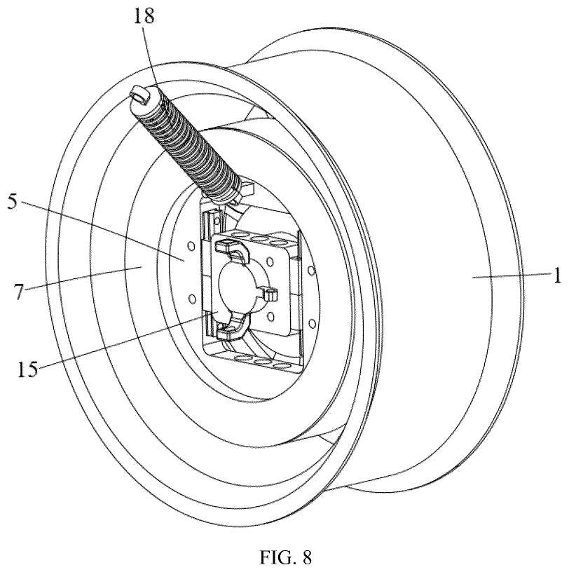

Referring to FIG. 8, different from Embodiment 1, a number of the vertical vibration absorbers 17 and/or vibration absorption springs 16 is zero.

In this technical solution, the vertical vibration absorber and/or vibration absorption springs are not disposed, the center block is still able to slide along the guide rails under the action of the hub; and due to the limiting effect of the connecting rods or the like, the center block has a limited range of up and down movement and cannot collide with the inner walls of the rectangular slot, thereby ensuring the relatively stable position of the hub motor, avoiding the influence of vibration on the hub motor, and prolonging the service life of the hub motor.

### EMBODIMENT 3

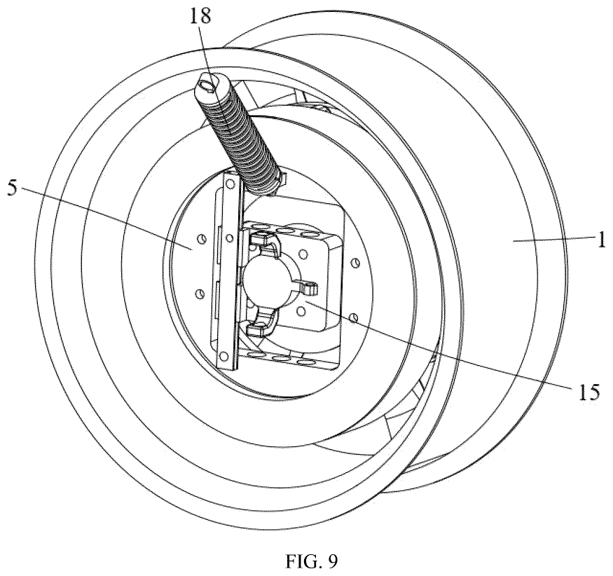

Referring to FIG. 9, different from Embodiment 1 or Embodiment 2, the two guide rails 13 (one guide rail is omitted in the figure) are disposed on the side surface of the stator support 5 far away from the intermediate disc 8 in parallel, and the side surface of the center block 15 close to the stator support 5 is slidingly connected to the guide rails 13 through the sliding blocks 14.

In this technical solution, the guide rails are disposed such that the center block can slide up and down along the guide rails; and the vertical vibration absorber is disposed as long as it is staggered from the guide rails and the sliding blocks.

### EMBODIMENT 4

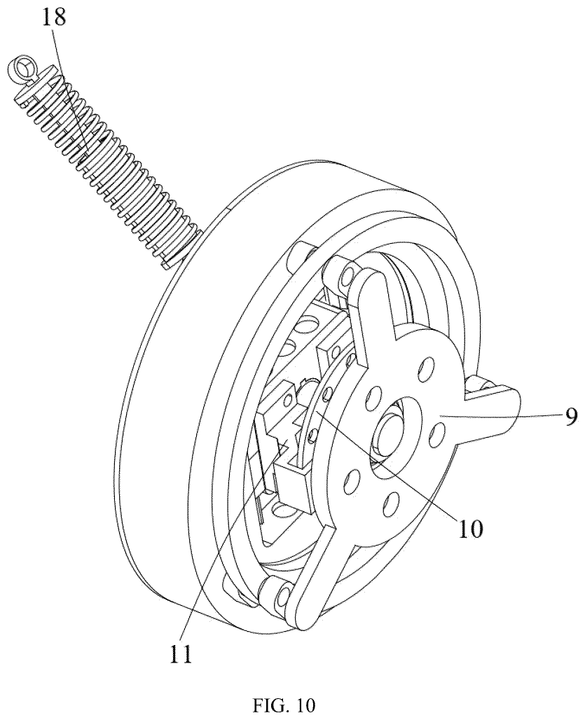

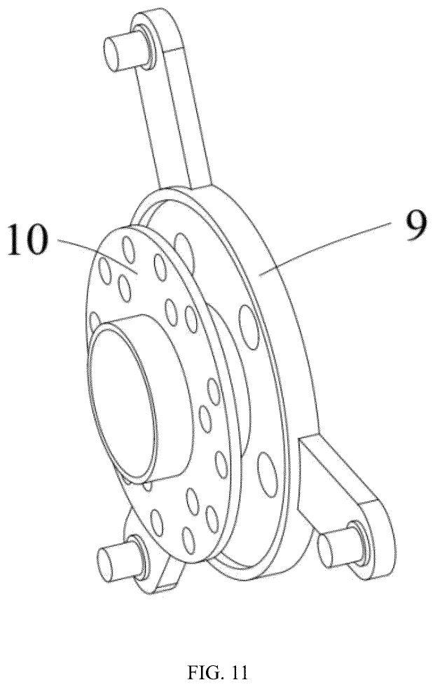

Referring to FIG. 10 and FIG. 11, different from the above embodiments, the brake bottom plate is sleeved on the driving disc and fixed in a manner of welding or integrated molding, and the brake shoe assembly is a brake caliper structure, is fixed to the center block, and can act on the brake bottom plate to form a disc brake structure.

### EMBODIMENT 5

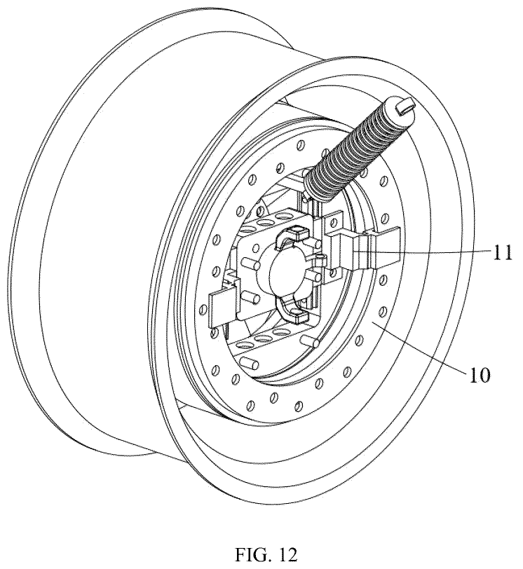

Referring to FIG. 12, different from the above embodiments, the brake bottom plate only needs to be removed from the driving disc on the basis of Embodiment 4, the brake bottom plate is fixed to the motor rear cover by welding or the like, an outer edge of one side of the brake bottom plate close to the motor rear cover is provided with a boss for separating the brake bottom plate from the motor rear cover, a space for containing the brake shoe assembly is left, and the brake shoe assembly is of a brake caliper structure, is fixed to the stator support and acts on the brake bottom plate to form a disc brake structure.

### EMBODIMENT 6

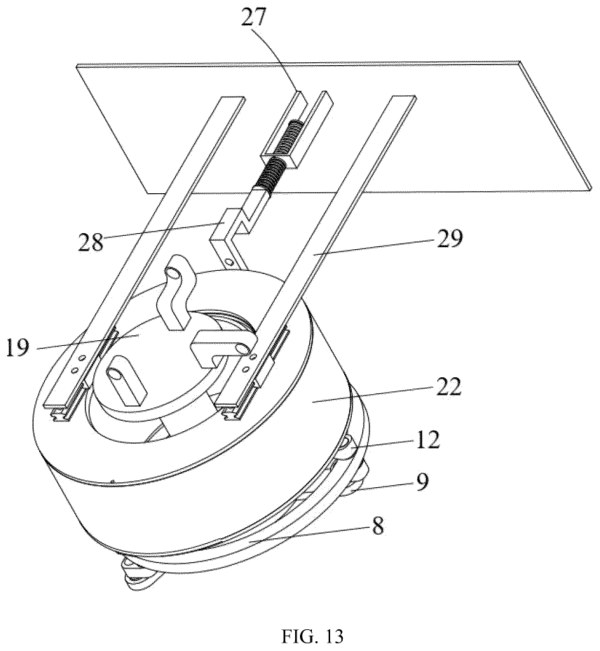

Exemplarily, referring to FIG. 13, different from the above embodiments, the hub motor is an inner-rotor motor or an axial flux motor and includes a stator disposed in a housing 22, a rotor, and a rotor shaft 23 drivingly connected to the rotor, and the rotor shaft 23 is of a hollow structure; the intermediate disc 8 is drivingly connected to the hub motor and the driving disc 9, the intermediate disc 8 is drivingly connected to the hub motor through a planetary mechanism, the steering knuckle 19 is slidingly connected to an end cap of the housing 22, the steering knuckle 19 is rotationally connected to the driving disc 9, one end of the pull-up vibration absorber is connected to the housing 22 of the hub motor, the other end of the pull-up vibration absorber is connected to the frame of the vehicle, the pull-up vibration absorber may also be replaced by the diagonal vibration absorber, the hub motor is slidingly connected to the frame through a connection rod 29, and the connection rod 29 has a top end connected to a mounting plate and a bottom end slidingly connected to the hub motor through the linear guide rails.

### EMBODIMENT 7

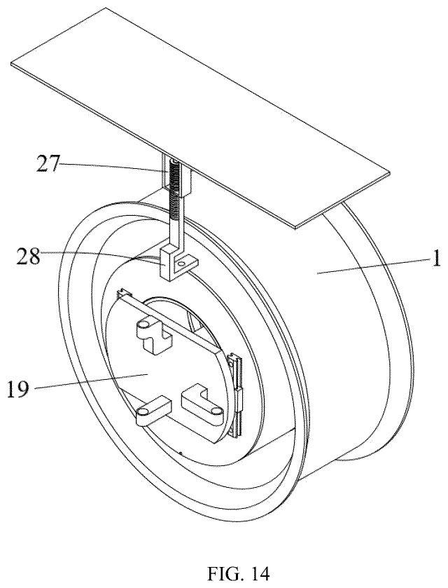

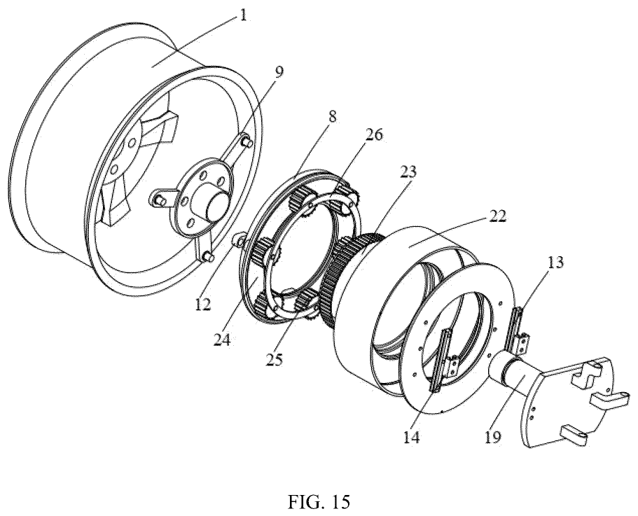

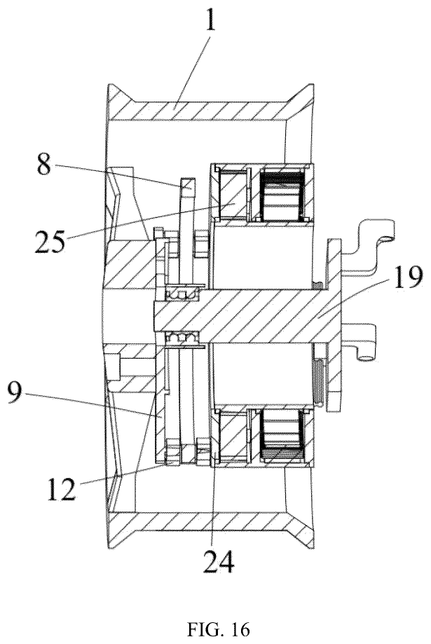

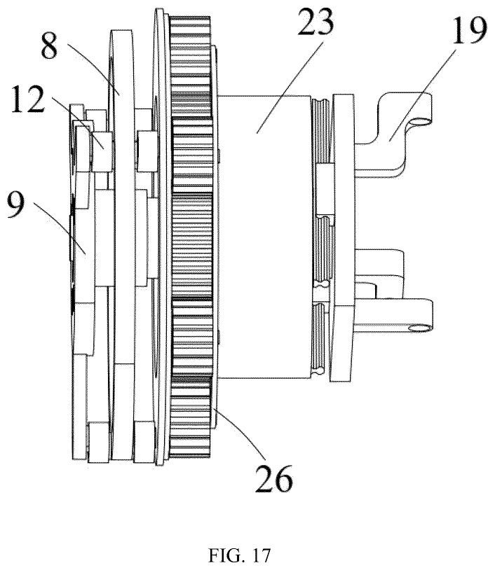

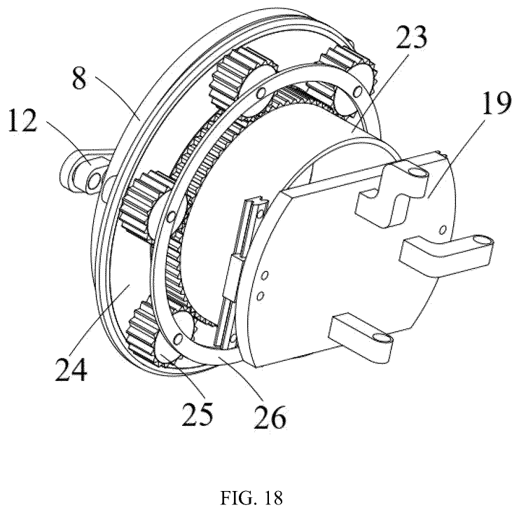

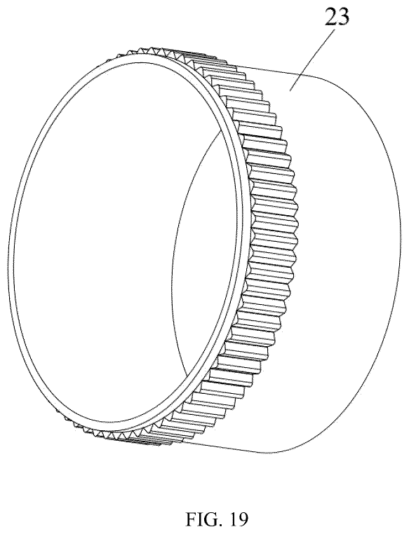

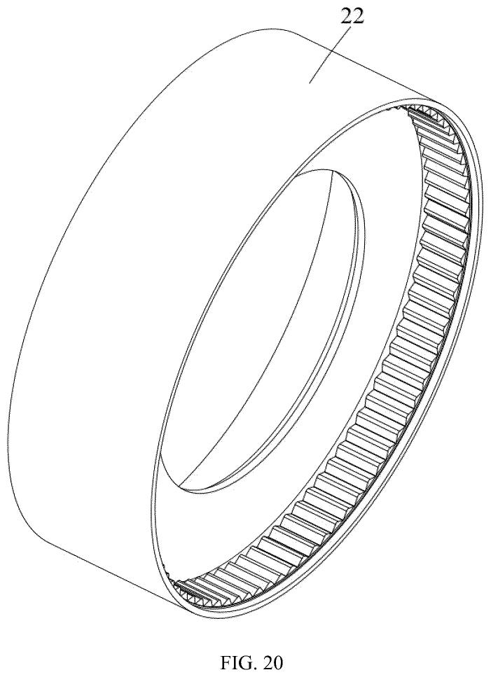

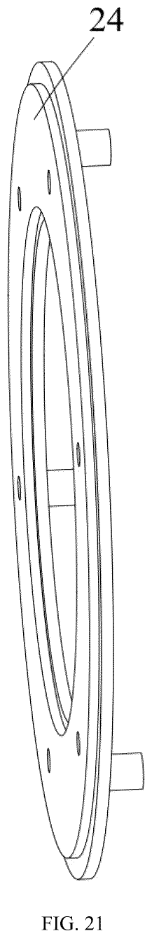

Exemplarily, referring to FIG. 14 to FIG. 21, different from Embodiment 6, the steering knuckle 19 is slidingly connected to the end cap of the housing 22, the steering knuckle 19 is rotationally connected to the driving disc 9, and the pull-up vibration absorber has one end connected to the housing 22 of the hub motor and the other end connected to the frame of the vehicle.

In this technical solution, the steering knuckle includes a connecting plate as well as a connecting shaft and a connector which are disposed on two sides of the connecting plate, respectively, the connecting plate is slidingly connected to the end cap of the hub motor, the connector is connected to the steering mechanism of the vehicle through the conventional connecting structure, the connecting shaft penetrates the hub motor to be rotationally connected to the driving disc through a bearing and a nut or the like, and steering of the hub is achieved through the steering knuckle; the hub motor is the inner-rotor motor or the axial flux motor, the stator is fixed in the housing, the rotor is disposed in the stator or on two sides of the stator and fixed to an outer wall of the rotor shaft, after the hub motor is energized, the rotor drives the rotor shaft to rotate, and a driving force is transmitted to the hub of the vehicle through the torque transmission mechanism composed of the planetary mechanism together with the intermediate disc and the driving disc, thereby driving the vehicle to travel; the pull-up vibration absorber pulls the housing of the hub motor upward, the entire weight of the hub motor is transferred upward to the frame of the vehicle, when the vehicle is driving on a road surface, the weight of the hub motor cannot be directly applied to the hub to ensure that the vehicle travels with the hub without loads, and when the road surface is rough or has obstacles, the hub of the vehicle can move up or down through obstacles with light and fast speed, the hub drives the steering knuckle to slide with respect to the hub motor, and the high-frequency large-amplitude momentary impact force is absorbed in the forms of thermal energy and elastic deformation under the action of the pull-up vibration absorber, thereby ensuring that the hub motor and the hub of the vehicle maintain relatively smooth positions to provide comfort and manoeuvrability for driving the vehicle.

Exemplarily, referring to FIG. 14 to FIG. 21, the planetary mechanism includes an internal gear ring disposed on an outer wall of the rotor shaft 23, an external gear ring disposed on an inner wall of the housing 22, and several planet gears 25 disposed on a first planet carrier 24, and one end of the first planet carrier 24 that is far away from the planet gears 25 is drivingly connected to the intermediate disc 8.

In this technical solution, the internal gear ring is directly machined to the outer wall of the rotor shaft, i.e., the internal gear ring and the rotor shaft are integrally formed, or the internal gear ring is machined and then fixed to a corresponding position of the outer wall of the rotor shaft by conventional devices such as a jackscrew and a key; one end of a housing of the hub motor close to a connecting block of the steering knuckle is encapsulated by the end cap, the end cap and the rotor shaft are rotationally connected through conventional structures such as step grooves and bearings, the other end of the housing extends toward the intermediate disc, an annular diaphragm runs on the inner wall of the housing, an inner cavity of the housing is divided into a motor cavity and a gear cavity, the rotor and the stator or the like are encapsulated within a housing, ingress of foreign objects is avoided, the annular diaphragm and the rotor shaft are rotationally connected through conventional structures such as step grooves and bearings, an external gear ring support is machined on the inner wall of the housing i.e., the outer gear and the housing are integrally formed, or the external gear ring is machined and then fixed to the corresponding position of the inner wall of the housing through conventional devices such as a jackscrew and a key, a planet gear is rotationally disposed on the first planet carrier through a rotating shaft, the first planet carrier is rotationally connected to the housing and the rotor shaft through conventional structures such as step grooves and bearings, respectively, and when the rotor shaft rotates, the planet gear is driven to rotate along its rotating shaft and revolve along the external gear ring, and the first planet carrier is driven to rotate, thereby driving the hub to rotate through the intermediate disc and the driving disc.

Exemplarily, referring to FIG. 14 to FIG. 21, one end of the planet gear 25 far away from the torque transmission mechanism is provided with a second planet carrier 26.

In this technical solution, the second planet carrier is of a ring structure, and two ends of the rotating shaft of the planet gear are connected to the first planet carrier and the second planet carrier, respectively, so that the stability of mounting of the planet gear is improved.

Exemplarily, referring to FIG. 13 to FIG. 21, the steering knuckle 19 is slidingly connected to the end cap of the housing 22 through the guide rails 13 and the sliding blocks 14.

In the technical solution, the linear guide rails are vertically disposed on two sides of the end cap of the housing through bolts or the like, the connecting plate of the steering knuckle is connected to the sliding blocks of the guide rails through bolts, in the horizontal direction, the hub motor, the steering knuckle, and the hub are fixed to each other, and when the hub jounces, the steering knuckle is driven to move along the direction of the guide rails to reduce the influence on the hub motor; and the linear guide rails may also be fixed to the connecting block of the steering knuckle, and the sliding blocks are fixed to the end cap of the housing.

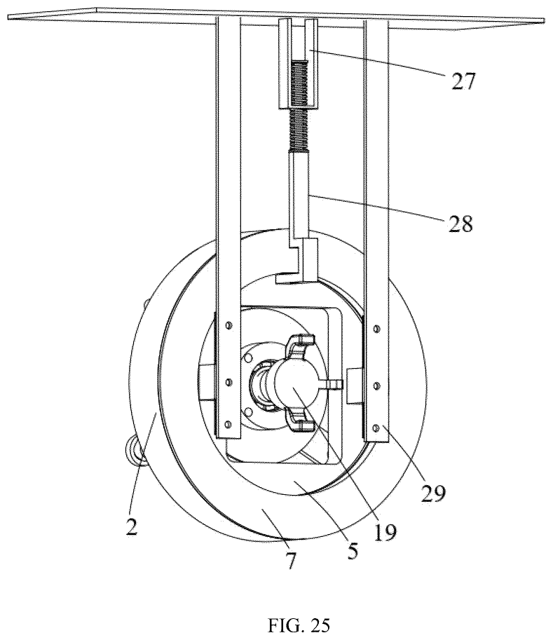

Exemplarily, referring to FIG. 14 and FIG. 25, the pull-up vibration absorber includes a spring support 27 disposed on a vehicle body and a tension rod 28 elastically connected between the spring support 27 and the hub motor, and the spring support 27 is connected to the steering knuckle 19 through the tension rod 28.

In this technical solution, the spring support includes a mounting plate and a slot-type block which are fixed to each other, the mounting plate is fixed to the frame in manners such as bolts or welding, it is also possible to dispose the slot-type block directly to the frame, the tension rod has a top end of a cylindrical structure and slides through the slot-type block, two ends inside and outside the slot-type block are sleeved with springs, the springs are limited by conventional structures such as nuts, when the tension rod moves upward or downward, the tension rod is elastically connected to the spring support to reduce the influence of vibration or the like on the hub motor, and the tension rod has a bottom end of a bent structure to avoid interference with the hub or the like and is connected to the hub motor in manners such as bolts or welding or the like to transfer the entire weight of the hub motor upward to the frame of the vehicle.

### EMBODIMENT 8

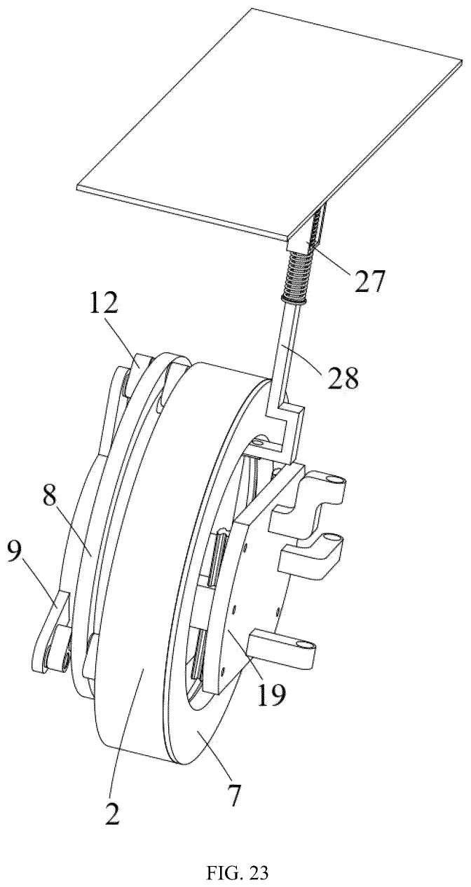

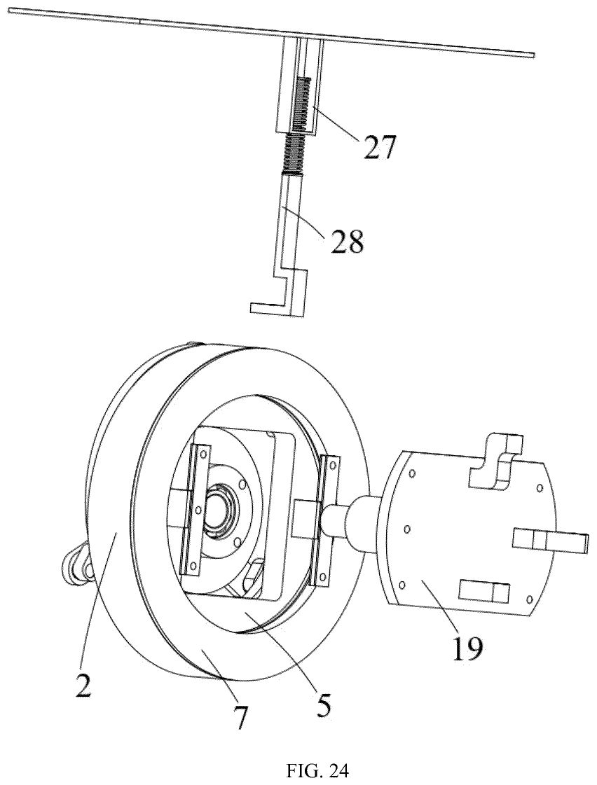

Exemplarily, referring to FIG. 23 and FIG. 24, the pull-up vibration absorber may also be applied to an outer-rotor hub motor, and the bottom of the tension rod 28 is connected to the stator support 5 of the hub motor.

In this technical solution, the hub motor is the outer-rotor hub motor, a positioning block is directly replaced with the connecting plate of the steering knuckle and is slidingly connected to the side surface of the stator support through the guide rails and the sliding blocks, the pull-up vibration absorber and the diagonal vibration absorber may be used simultaneously or alternatively, and the bottom of the tension rod of the pull-up vibration absorber only needs to be connected to the stator support of the hub motor.

### EMBODIMENT 9

Exemplarily, referring to FIG. 25, the hub motor is the outer-rotor hub motor, the bottom of the tension rod 28 only needs to be connected to the stator support 5 of the hub motor, the steering knuckle is not in contact with the stator support, and the connection rod 29 has a top end connected to the mounting plate/frame and a bottom end slidingly connected to the hub motor through the linear guide rails.

### EMBODIMENT 10

The vibration absorption system of the hub motor in the above embodiments is applied to a wheel, the hub is sleeved with a conventional tire, and an electric wheel can be formed.

### EMBODIMENT 11

The wheel in the above embodiments to the vehicle, the steering knuckle is connected to the steering system of the vehicle, the hub motor is electrically connected to a battery and a control system of the vehicle, and the hub motor is connected to the frame of the vehicle through the diagonal vibration absorber to reduce a downward acting force of the hub motor on the vehicle hub and increase a response speed of up-and-down vibration of the hub in the traveling process.

In summary, the vibration absorption system of the hub motor is compact in structure; on one hand, the torque transmission mechanism is composed of the hub motor front cover together with the intermediate disc and the driving disc, equal torque and equal rotational speed of the hub motor are indirectly transmitted to the vehicle hub, the vehicle hub can vibrate up and down within a range of motion of the torque transmission mechanism, and a vibration frequency and a vibration amplitude cannot be transmitted to the hub motor; on the other hand, the motor stator support bears the weight of the hub motor, and the weight of the hub motor is transferred to the vehicle frame through the diagonal vibration absorber, thereby relieving a downward acting force of the hub motor on the vehicle hub; at the same time, a high-frequency large-amplitude impact force generated by the vehicle hub during driving on the ground is absorbed through the vibration absorption mechanism to ensure that the hub motor keeps the relative position stable; and the vibration absorption springs and the vertical vibration absorber can quickly adjust the center block and the center position the stator support through vibration absorption and damping effects to adjust the hub motor and the vehicle hub to keep the relative stable positions and provide comfort and maneuverability for driving the vehicle.

It should be noted that relational terms such as first and second are used herein merely to distinguish one entity or operation from another entity or operation and do not necessarily require or imply the existence of any such actual relationship or sequence between these entities or operations. Moreover, the terms “include”, “comprise”, or any other variants thereof are intended to cover non-exclusive inclusion, so that a process, method, item, or device including a series of elements includes not only those elements but also other elements not explicitly listed, or further includes inherent elements of such process, method, item, or device. An element defined by “includes a . . . ” does not, without more constraints, preclude the existence of additional identical elements in the process, method, article, or device that includes the element.

The above are only preferred implementations of the present application. It should be noted that, for those of ordinary skill in the art, a plurality of improvements and modifications may be made without departing from the principle of the present application, and the improvements and modifications are also regarded to be within the protection scope of the present application.

What is claimed is:

1. A vibration absorption system of a hub motor, comprising: a hub, a hub motor, a torque transmission mechanism, a vibration absorption mechanism, and a pull-up vibration absorber, wherein
the torque transmission mechanism comprises a driving disc drivingly connected to the hub motor through an intermediate disc, the driving disc is connected to the hub, the intermediate disc is drivingly connected to the hub motor, and two sides of the intermediate disc are connected to the hub motor and the driving disc through several connecting rods, respectively;
a vibration absorption mechanism comprises a steering knuckle, the steering knuckle is rotationally connected to the driving disc, and the hub motor is slidingly connected to the steering knuckle or slidingly connected to a frame through connection rods; and
the pull-up vibration absorber has one end connected to the hub motor and the other end connected to a frame of a vehicle.

2. The vibration absorption system of a hub motor according to claim 1, wherein the hub motor is an inner-rotor motor or an axial flux motor, and comprises a stator disposed in a housing, a rotor, and a rotor shaft drivingly connected to the rotor, the rotor shaft is of a hollow structure, and the intermediate disc is drivingly connected to the hub motor through a planetary mechanism.

3. The vibration absorption system of a hub motor according to claim 2, wherein the planetary mechanism comprises an internal gear ring disposed on an outer wall of the rotor shaft, an external gear ring disposed on an inner wall of the housing, and several planet gears disposed on a first planet carrier, one end of the first planet carrier that is far away from the planet gears is drivingly connected to the intermediate disc, and the ends of the planet gears that are far away from the torque transmission mechanism are provided with a second planet carrier.

4. The vibration absorption system of a hub motor according to claim 1, wherein the hub motor is an outer-rotor motor and comprises a motor front cover, a rotor iron core, permanent magnets, a stator iron core, a stator support, a motor bearing, and a motor rear cover.

5. The vibration absorption system of a hub motor according to claim 4, wherein the steering knuckle comprises a connecting plate as well as a connecting shaft and a connector which are disposed on two sides of the connecting plate, respectively, and a side surface of the connecting plate that is close to the hub motor is slidingly connected to a side surface of the stator support.

6. The vibration absorption system of a hub motor according to claim 4, wherein each connection rod has one end connected to the side surface of the stator support, respectively, and the other end connected to the frame.

7. The vibration absorption system of a hub motor according to claim 4, wherein the intermediate disc is drivingly connected to the motor front cover through several connecting rods, a brake bottom plate and a brake shoe assembly for braking are disposed in the driving disc, the brake bottom plate is fixed to the steering knuckle, a center block is slidingly disposed in the stator support, an end surface of one side of the brake bottom plate is fixed to the center block, vibration absorption springs and a vertical vibration absorber are connected between the center block and the stator support, and the stator support has the side surface provided with a first fixing post and is connected to the frame of the vehicle through a diagonal vibration absorber.

8. The vibration absorption system of a hub motor according to claim 1, wherein one end of each connecting rod disposed close to the driving disc is connected to the driving disc through a first shaft pin, one end of each connecting rod disposed close to the hub motor is connected to the hub motor through a second shaft pin, one end of each connecting rod that is far away from the corresponding first shaft pin or the corresponding second shaft pin is connected to the intermediate disc through a third shaft pin, the first shaft pins, the second shaft pins and the third shaft pins are respectively arrayed on a circumference of the same diameter size at an equal interval, and a number of the connecting rods disposed between the driving disc and the intermediate disc and a number of the connecting rods disposed between the motor front cover and the intermediate disc are at least 3.

9. The vibration absorption system of a hub motor according to claim 8, wherein rotating arms respectively corresponding to the first shaft pins are disposed on the outer wall of the driving disc in a protruding manner, and the intermediate disc is disposed between the rotating arms and the hub motor and is sleeved on the driving disc in a suspended manner.

10. The vibration absorption system of a hub motor according to claim 8, wherein a rectangular slot is disposed in a middle of the stator support, two sides of the center block are slidingly connected to inner walls of two opposite sides of the rectangular slot through guide rails and sliding blocks, respectively, side surfaces of the stator support and the center block that are close to the diagonal vibration absorber are respectively provided with second fixing posts for mounting of the vertical vibration absorber, and the vibration absorption springs are respectively disposed between the center block and side walls of the rectangular slot that are perpendicular to the guide rails.

11. The vibration absorption system of a hub motor according to claim 8, wherein the guide rails are disposed on a side surface of the stator support that is far away from the intermediate disc in parallel, and the center block is slidingly connected to the guide rails through the sliding blocks.

12. A wheel, comprising the vibration absorption system of a hub motor according to claim 1, wherein a hub is sleeved with a tire.

13. A vehicle, comprising the tire according to claim 12.
